(19) United States
(12) Patent Application Publication
(10) Pub. No.: US 2020/0338490 A1
(43) Pub. Date: Oct. 29, 2020

(54) Filtering Detection Device

(71) Applicant: Jason Yan, New Taipei City (TW)

(72) Inventor: Jason Yan, New Taipei City (TW)

(21) Appl. No.: 16/503,638

(22) Filed: Jul. 5, 2019

(30) Foreign Application Priority Data
Apr. 23, 2019 (TW) 108204976

(51) Int. Cl. B01D 46/00; G01N 15/08; G08B 21/18; G08B 7/06; B01D 46/44; B01D 46/10; B01D 46/46

(52) U.S. Cl. CPC B01D 46/0086; G01N 15/0806; G08B 21/18; G08B 7/06; B01D 2279/45; B01D 46/0043; B01D 46/10; B01D 46/46; G01N 2015/084; B01D 46/444

(57) ABSTRACT

A filtering detection device mainly comprises a filter, a fan and a detector. The filter is disposed on a machine housing of an electronic device, the fan is disposed at a position corresponding to the filter inside the machine, and the detector is disposed between the fan and the filter. The present invention uses the detector to detect the air flow velocity or flow rate of outside air entering the machine through the filter when the outside air is pumped into the machine through the filter. The detector determines whether the filter is clogged or not by detecting if the air flow rate or flow rate detected by the detector is reduced, then an alarm device electrically connected with the detector can be used to notify a user to replace the filter.

### BACKGROUND OF THE INVENTION

### Field of the Invention

The present invention relates to a detection device, and more particularly, to a filtering detection device for detecting whether the filtering performance is reduced due to dirty clogging the filter.

### Description of the Prior Art

The electronic components inside the electronic devices in the market generate heat during operation, and the heat energy will continuously accumulate inside the electronic device, which will cause the temperature inside the electronic device to rise. To prevent the electronic components from malfunctioning or burning due to the rising temperature, cooling fans are user for sucking the external cool air into the electronic device to achieve cooling effect. However, when the cooling fan is sucking the external cool into the electronic device, the external dust is also sucked into the electronic device and accumulates inside the electronic device, which not only affects the performance of the electronic components, but also causes the electronic components to malfunction. Therefore, most electronic devices install a filter to filter the dust.

In addition, there are also some electronic products such as air filters or air conditioners, which install filters and fans to assist the functions provided by the electronic products.

However, regardless of the function required for heat dissipation or the electronic product itself, the structure of using the filter and the fan may cause the filter to become dirty more and more after a long time, and cause the fan to slow down or stop working due to a malfunction. However, the current methods for solving this problem are mostly detecting the fan speed to determine whether the fan is aging, and asking the user to visually examine the filter to see if it's necessary to replace the filter.

Although most manufacturers of electronic devices often remind users in the instruction manual that they need to clean or replace the filter regularly, most users do not follow the instruction, which makes the performance of electronic products become lower.

Therefore, the Taiwan Patent No.I646420 titled “WARNING SYSTEM FOR LIFE OF FILTER OF HVAC AND WARNING METHOD FOR USING THE SAME” provides a method which mainly calculates the life of the filter according to the number of fan segments, environmental parameters and running time to remind the user to replace the filter, and the Taiwan Patent No.I607191 “VENTILATION EQUIPMENT HAVING DIRTY FILTER DETECTING FUNCTION AND DETECTING METHOD OF THE VENTILATION EQUIPMENT” provides a method to judge the time for replacing the filter through the pressure difference in the machine. However, the patent is applicable to a large-scale machine with sufficient computing equipment, such as an air-conditioning device, and cannot be applied to other small and medium-sized electronic devices.

As mentioned above, there are still quite a few problems in the prior art technique. Therefore, in view of the above problems, after years of research, the inventor of the present invention has successfully developed and proposed the filtering detection device of the present invention.

### SUMMARY OF THE INVENTION

In order to solve the above problems, it is an object of the present invention to provide a filtering detection device which can effectively detect whether a filter is clogged to replace the filter in real time.

In order to achieve the above object, the filtering detection device of the present invention is disposed on a machine, which may be a computer host, an air filter, a dehumidifier, an air conditioner, a sweeping robot, an air conditioner, or other machines, the filtering detection device comprises a filter, a fan, a detector and a warning device.

The filter is disposed on the housing of the machine, and the fan is disposed at a position corresponding to the filter inside the machine, and the detector is disposed between the fan and the filter in the machine.

The warning device is electrically connected with the detector, and the warning device is a warning light or a buzzer.

The filtering detection device of the present invention further comprises a display device, and the warning device is a wireless signal transmitter which can transmit a warning signal to the display device for warning.

Furthermore, the detector is an air flow amount detector, flow rate detector, or air flow amount and flow rate detector

### BRIEF DESCRIPTION OF THE DRAWINGS

The techniques of present invention would be more understandable from the detailed description given herein below and the accompanying figures are provided for better illustration, and thus description and figures are not limitative for present invention, and wherein:

FIG. 1 illustrates a structural diagram of a filtering detection device of the present invention;

FIG. 2 illustrates a circuit block diagram of a filtering detection device of the present invention; and

FIG. 3 illustrates a circuit block diagram of another embodiment of a filtering detection device of the present invention.

### DETAILED DESCRIPTION OF THE INVENTION

The invention will be described with reference to the accompanying drawings, and the embodiments of the present invention are described in detail below, and the drawings used in the context are used to describe the features, the contents and the advantages of the invention. The drawings of the present invention are intended to be illustrative only and to assist the description in the specification, and are not intended to limit the scope of the invention in practice.

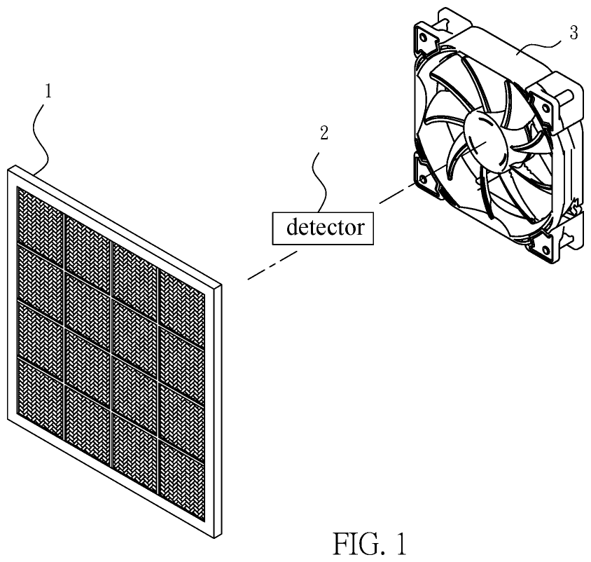

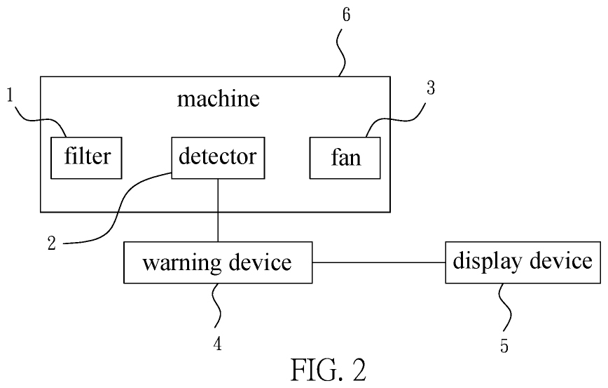

Referring to FIG. 1 and FIG. 2, the filtering detection device of the present invention mainly comprises a filter 1, a detector 2, a fan 3, a warning device 4, and a display device 5, wherein the display device 5 is a smart mobile device or a computer, the warning device is a wireless signal transmitter 4, the filter 1 is a removable filter 1 disposed on a housing of a machine 6, the fan 3 is disposed at a position corresponding to the filter 1 inside the machine 6, and the detector 2 is disposed between the filter 1 and the fan 3 in the machine 6 and electrically connected with the wireless signal transmitter 4, the detector 2 is an air flow amount detector or a flow rate detector.

When the filtering detection device of the present invention is used, the air outside the machine 6 is extracted by the fan 3, so that the air outside the machine 6 enters the machine 6 through the filter 1 to reduce the internal temperature of the machine 6; or the air outside the machine 6 enters the machine 6 for filtering or heat exchange, and the air is passed through the detector 2 disposed between the fan 3 and the filter 1 to detect the air flow amount or flow rate, and when it is detected that the air flow amount or the flow rate entering the machine 6 is reduced, it means that the filter 1 is dirty and clogged. At this time, the detector 2 transmits a warning signal through the wireless signal transmitter 4 to the display device 5 to notify the user that the filter 1 needs to be replaced.

When the air outside the machine 6 enters the machine 6 through the filter 1, a portion of the dust is filtered by the filter 1, so the user can set the air detected by the detector 2 to detect that, when the air flow amount or the flow rate is reduced to a certain extent, then the detector 2 transmits a warning signal to the display device 5 through the wireless signal transmitter 4 to issue a warning, so as to prevent the filtering detection device of the present invention from being activated every time the detector 2 detects that the air flow amount or flow rate is reduced.

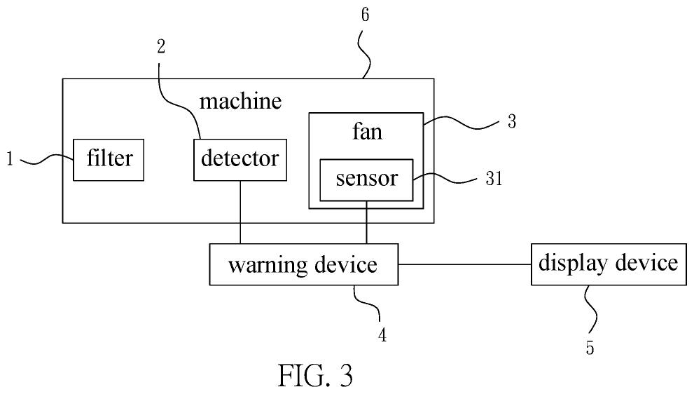

In addition, referring to FIG. 3, the filtering detection device of the present invention can also provide a sensor 31 on the fan 3 for detecting the rotation speed of the fan 3 to prevent the aging failure of the fan 3 to cause the rotation speed to decrease and the air flow amount or flow rate detected by the detector 2 to reduce as well, resulting in that the filter 1 could be determined to be dirty and clogged. Besides, the sensor 31 can also be connected to the wireless signal transmitter 4, when the sensor 31 detects that the fan speed drops, a warning signal is sent to the display device 5 through the wireless signal transmitter 4 to notify the user that the fan 3 has failed.

As described above, the filtering detection device of the present invention can prevent the filter from being dirty and clogged due to the user forgetting to replace the filter, resulting in that the internal electronic components of the machine are overheated or burned due to rising internal temperature, furthermore, the invention is simpler in structure compared with those of the Taiwan Patent Nos.I646420 and I607191, and the present invention can notify the user to replace the filter without a powerful computing device and can be applied to all small and medium-sized machines. Therefore, the filtering detection device of the present invention has met the requirements for novelty, advancement and industrial utilization, and is applied for a patent according to the law.

The present invention has been described with preferred embodiment of the present invention; however, this embodiment is not intended to limit the scope of the patent of the present invention. Many changes and modifications in the above described embodiment of the invention can, of course, be carried out without departing from the scope thereof.

What is claimed is:

1. A filtering detection device comprising:
a filter disposed on a machine;
a fan disposed at a position corresponding to the filter inside the electronic device, wherein the fan is used for pumping an outside air into the machine through the filter; and
a detector disposed between the filter and the fan and provided for detecting the air flow amount or flow rate of outside air entering the machine through the filter.

2. The filtering detection device as claimed in claim 1 further comprising a warning device, wherein the warning device is electrically connected with the detector to issue a warning when the air flow amount or flow rate of the outside air detected by the detector is reduced.

3. The filtering detection device as claimed in claim 2, wherein the warning device is a warning light, a buzzer or a wireless signal transmitter that transmits a warning signal to a display device for warning.

4. The filtering detection device as claimed in claim 1, wherein the machine is a computer host, an air filter, a dehumidifier, an air conditioner, a sweeping robot, an air conditioner, or other machine that needs to filter the outside air with a filter.

5. The filtering detection device as claimed in claim 1, wherein the detector is an air flow amount detector, flow rate detector, or air flow amount and flow rate detector.

6. The filtering detection device as claimed in claim 1, wherein the fan is further disposed with a sensor for measuring the speed of the fan.
